(19) United States
(12) Patent Application Publication
(10) Pub. No.: US 2003/0014497 A1
(43) Pub. Date: Jan. 16, 2003

(54) Information push through simulated context activation

(76) Inventors: Jogen Pathak, Dallas, TX (US); Vyankatesh Shanbhag, Plano, TX (US)

Correspondence Address: R. SCOTT RHOADES, STRASBURGER, & PRICE, LLP, 901 MAIN STREET, SUITE 4300, DALLAS, TX, 75202-3794, US

(21) Appl. No.: 09/929,418

(22) Filed: Aug. 13, 2001

Related U.S. Application Data
(60) Provisional application No. 60/304,126, filed on Jul. 10, 2001.

(51) Int. Cl. G06F 15/16

(52) U.S. Cl. 709/217; 709/230

(57) ABSTRACT

A system and method for establishing a server initiated data connection with a particular wireless client are presented herein. A wireless content switch is inserted into the wireless data service network and receives requests for data connections with particular wireless content switches from content servers. Responsive to receiving the request, the wireless content switch transmits signals to the wireless client causing the wireless client to request a data connection with the content server. During the processing of the request, the wireless network transmits a signal embedded with an address associated with the wireless client which is received by the wireless content switch. The wireless content switch transmits a signal which provides the address to the content server. Upon receiving the address, the content server transmits data with the foregoing address.

### PRIORITY DATA

This application claims the priority benefit of U.S. Provisional Application for Patent, Serial No. 60/304,126, filed Jul. 10, 2001, by Pathak et. al., which is hereby incorporated by reference for all purposes.

### FIELD

The present application is directed to wireless data services, and more particularly, to pushing information through simulated content activation.

### BACKGROUND

General packet radio services (GPRS) is one of the leading protocols for the packet data services over a wireless network. GPRS allows for the establishment of a client/server or peer to peer connection between a wireless client and a content server connected to the internet or other such network.

A client initiated connection occurs when the connection is established in response to a request from the client. A server initiated client/server connection occurs when the client/server connection is established responsive to a request from the server or the network.

Historically, connections between wireless clients and content servers were almost exclusively client initiated. However, the GPRS and other such networks such as 3G DSL define “always on” connectivity which permits server initiated connections. The protocols require adapting certain network elements in accordance with the GPRS definitions. Vendors, however, generally have not adapted their equipment in accordance with GPRS server initiated client/server connection establishment for various reasons.

One of the challenges facing vendors is the growing scarcity of Internet Protocol (IP) addresses. In order to effectuate “always on” connectivity, an IP address must be allocated to each wireless client, in contrast to only wireless clients that have initiated a connection. As a result, a substantially greater number of IP addresses are required.

Another challenge arises from concerns about unsolicited server initiated client/server connections to the wireless clients. For example, a great deal of email messages are unsolicited advertisements, known as “spam” sent in bulk to millions of email accounts. The email messages are generally considered a nuisance by most email users. However, due to the large amounts of bandwidth in the wireline network, the cost of spam remain negligible. However, in wireless data networks, the bandwidth is more limited and the network can easily be overrun by excessive unsolicited server initiated client/server connections. The costs associated with unsolicited server initiated client/server connections for transmitting advertisements cannot be recovered by charging the users of the wireless client, because users generally find the advertisements to be an irritant.

Additional challenges are presented by mobility and routing support and security and privacy issues.

Accordingly, it would be beneficial if connections can be initiated by the server which address the foregoing challenges.

### SUMMARY

Presented herein is a system, method, and apparatus for facilitating server initiated connections in a wireless data packet network. A wireless content switch is inserted or incorporated onto a node defined by existing protocols between the wired network and the wireless client. When a content server requests a client server connection, a signal is transmitted to the wireless content switch which transmits a signal to a node which in turn transmits a signal to the wireless client. The signal transmitted to the wireless client causes the wireless client to initiate a request for a client server connection with the server. The request is received by the various network nodes which causes the network nodes to establish a tunnel for the transmission of data packets. Responsive to the establishment of the tunnel, the wireless content switch transmits a signal to the server indicating an address associated with the wireless client and identifying the nodes establishing the tunnel. The content server then transmits data packets to the wireless client using the address.

### BRIEF DESCRIPTION OF THE DRAWINGS

FIG. 1 is a block diagram of an exemplary communications network;

FIG. 2 is a conceptual diagram describing the operation of the communication network;

FIG. 3 is a block diagram of an exemplary GPRS communications network;

FIG. 4 is a signal flow diagram describing the operation of the GPRS communications network;

FIG. 5 is a block diagram of an exemplary wireless content switch; and

FIG. 6 is a block diagram of an exemplary content enabler.

### DETAILED DESCRIPTION

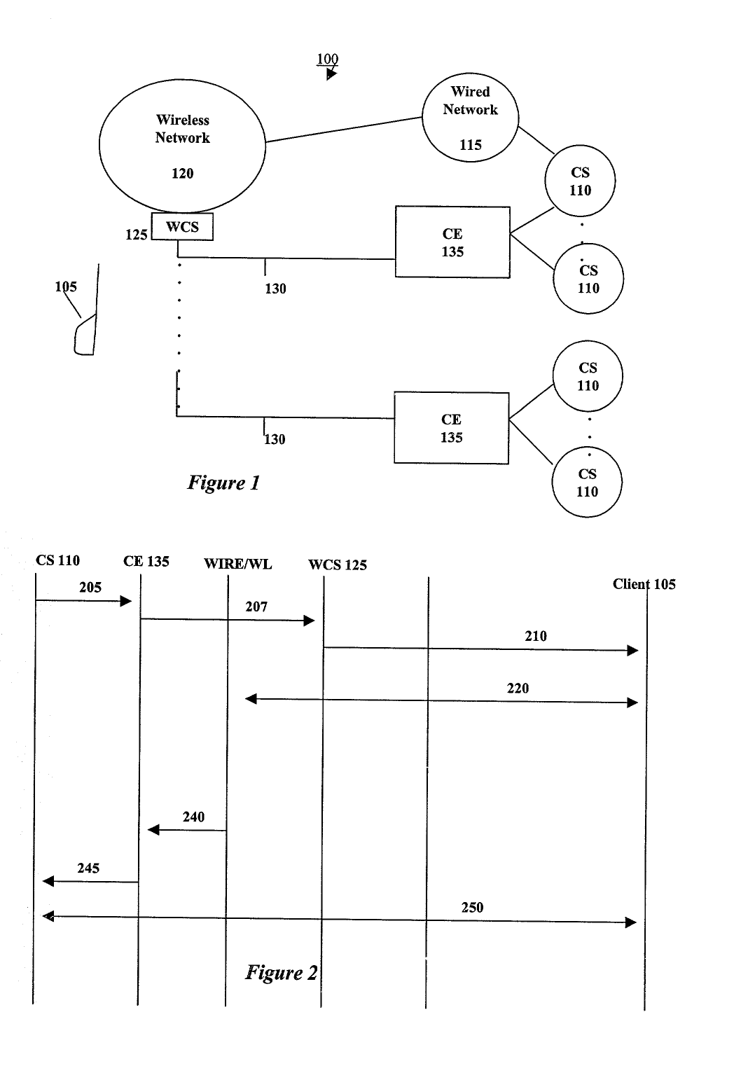

Referring now to FIG. 1, there is illustrated a block diagram of a communication network, referenced generally by the numeric designation 100, for transmitting data packets to a wireless client 105 from any one of a number of content servers 110. The wireless client 105 is a mobile terminal generally associated with a user or subscriber to the communication network 100, and can comprise, but is not limited to, a mobile station, a personal digital assistant, a lap top computer, or a palm top computer capable of engaging in wireless data communications.

The content server(s) 110 is a server computer which can include, for example, a web server. The content server 110 is generally connected to a wired network 115. The wired network 115 can comprise, for example, a local area network, a wide area network, or the internet.

The wired network 115 is interfaced with a wireless network 120 associated with the wireless client 105. The wireless network 120 is often a cellular telephone network which is adapted to provide packet data services, such as the Global System for Mobile Telecommunications (GSM). The wireless network 120 communicates with the wireless client 105 over the wireless air interface.

The wireless network 120 includes therein any number of wireless content switch(es) 125 which can be located anywhere within the wireless network 120. The wireless content switch 125 serves any number of wireless clients 105 and receives signaling information between the wireless client 105 and the wireless network 120, including information regarding the location of the wireless client 105 within the wireless network 120. Each wireless content switch 125 is connected via connection 130 to at least one content enabler 135. Although connection 130 is drawn as a direct connection 130 for purposes of clarity, it should be noted that the connection 130 is not necessarily a direct connection, and can comprise a connection over a network, such as wired network 115. Each content enabler 135 serves any number of content servers 110 and allows each of the served content servers 110 to initiate a data connection, such as, for example, a client/server connection, a peer to peer connection, or an information push session. The content enabler can be operated by the operators of the wireless network 120. Connections with the content servers 110 can be provisioned by various agreements, or subscriptions.

Referring now to FIG. 2, there is illustrated a conceptual diagram describing the operation of the communication network 100. The content server 110 indicates a request for a server initiated connection with a particular identified wireless client 105 by transmitting a request (signal 205) for a server initiated connection to the content enabler 135 associated therewith. The content enabler 135 transmits the request (signal 207) to the wireless content switch associated with the wireless client 105 via connection 130.

It is noted that the wireless network 120 can include numerous wireless content switches 125, each associated with a corresponding number of wireless clients 105. Furthermore, each content enabler 135 can be connected, either directly or over a network, to any number of wireless content switches 125. Accordingly, the content enabler 135 can transmit the request (signal 207) to the particular wireless content switch 125 associated with the wireless client 105 in one of several ways. In one case, the content enabler 135 can broadcast the request to all known wireless content switches 125, and the wireless content switches 125 can determine if the wireless client 105 is associated, therewith. In another case, the content enabler 135 can maintain a table corresponding the wireless clients 105 with the wireless content switch 125 associated therewith. The table can be maintained by periodic updates transmitted from the wireless content switches 125, which report each wireless client 105 served by the reporting wireless content switch 125.

Responsive to receiving the request for a server initiated connection from the content enabler 135, the wireless content switch 125 associated with the identified wireless client 105 transmits a signal to the wireless client 105 over the wireless network 120 (signal 210) indicating that the content server 110 is seeking to establish a data connection. The foregoing signal causes the wireless client 105 to establish a client initiated data connection with the content server 110.

The wireless client 105 transmits a request (signal 220) for client server connection with the content server 110 which, pursuant to the known protocols of the wireless network 115, causes a packet tunnel to be established from the interface with the wired network 115 towards the wireless content switch 125. The packet tunnel is characterized by the provision of sufficient bandwidth to allow for the transfer of data packets.

During establishment of the tunnel for the transfer of the data packets (signal 220), a signal is transmitted which includes routing information for packet data transfer. The foregoing routing information can include, for example, an address allocated to the wireless client 105 for data packet transfer. The signal is received by the wireless content switch 125 which forwards the routing information from signal 220 to the content enabler 135 associated with the requesting content server 110 (signal 245) via connection 130. The content enabler 135 then forwards the information (signal 245) to the requesting content server 110. Upon receiving the foregoing signal 245, the content server 110 uses the routing information contained therein to transmit the data packets over the wired network (signal 250) to the wireless client 125 via the tunnel.

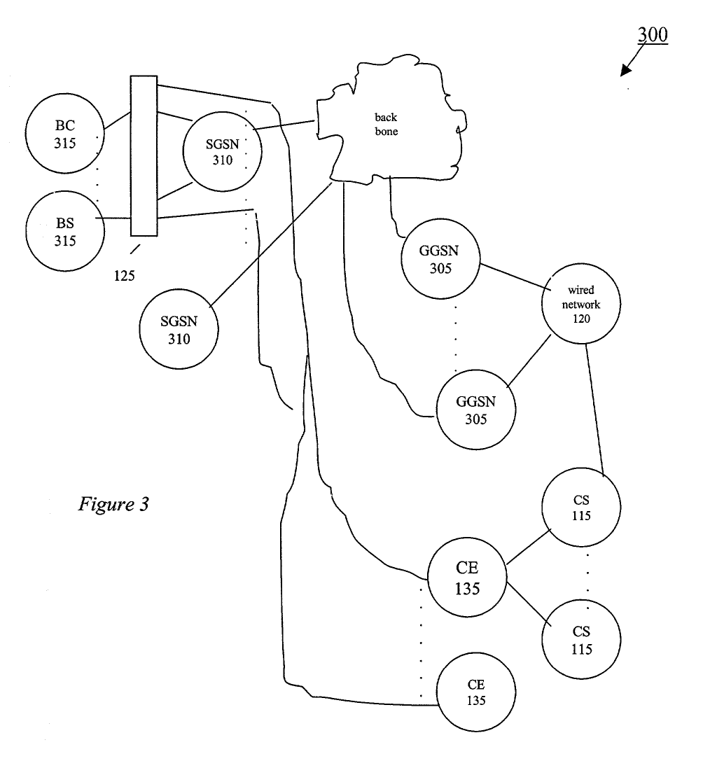

Referring now to FIG. 3, there is illustrated a block diagram of an exemplary communication network, referenced generally by the numeric designation 300, in accordance with Global System for Mobile Communications (GSM) specifications with GPRS functionality. It is noted that certain elements have been omitted for the purposes of simplicity and therefore, the FIGURE is not intended as an exhaustive illustration. Pursuant to GSM and GPRS specifications, the wireless network 120 is interfaced with the wired network 115 by any number of Gateway GPRS Support Nodes (GGSN) 305. Each GGSN 405 is associated with any number of IP addresses which the GGSN 305, in turn, allocates to wireless clients 105.

The wireless network 120 provides packet data services to geographical areas which are divided into routing areas. Each routing area is associated with a particular Serving GPRS Support Node (SGSN) 310. Each SGSN 310 is associated with any number of base station controllers 312. Each base station 312 controller is associated with and controls one or more base transceiver stations 315. The base transceiver station 315 is the radio transceiver equipment which transmits and receives signals to and from the wireless client 105. Base transceiver stations 315 maintain radio frequency communications within a geographic area known as a cell 320.

The SGSN 310 maintains communication link status to the wireless clients 105. The foregoing communications include regularly updated location information from the wireless client 105. On a periodic basis, the wireless client 105 transmits identification signals to the base transceiver station 315. The foregoing signals are forwarded from the base transceiver station 315 to the SGSN 310. Based on the identity of the base transceiver station 315 forwarding the signal, the SGSN 310 determines the identity of the cell 320 where the wireless client 105 is located. Additionally, when the wireless client 105 traverses the area of one cell 320 into another cell 320, the wireless client 105 registers with the base transceiver station 315 associated with the cell 320. Information from the foregoing registration is also forwarded to the SGSN 310, thereby providing the SGSN 310 with real-time location information. Wherein the wireless client 105 traverses the location area of one SGSN 310 to a second SGSN 310, the wireless client 105 registers with the second SGSN 310.

The SGSNs 310 and the GGSNs 305 are interconnected by a backbone network 325. The backbone network is a network which may form a portion of the wired network 115 and which routes packet data between the SGSNs 310 and the GGSNs 305. During transmission from the content server 110 to the wireless client 105, the content server 110 transmits the data packets to an IP address associated with the GGSN 315. The GGSN 315 receives the data packet, determines the identity and location of the wireless client 105 associated with the IP address. After determining the location of the wireless client 105, the GGSN 315 determines the SGSN 310 associated with the cell containing the wireless client 105 and forwards the packets to the wireless client 105 over the backbone network 115.

A wireless content switch 125 is associated with each SGSN 310 and receives all signal transmitted and received thereat. The wireless content switches 125 are placed between the SGSN 310 and the base stations 310. The signals include the location information, e.g., the cell identification, for the wireless clients 105. Each wireless content switch 125 is connected to any number of content enablers 135, via connection(s) 130. The connection(s) 130 are illustrated as direct connections for clarity, although the connections may be established over a network, such as wired network 115. Each content enabler 135 is connected to any number of content servers 110 and allows each of the served content servers 110 to initiate a data connection, such as, for example, a client/server connection, a peer to peer connection, or an information push session.

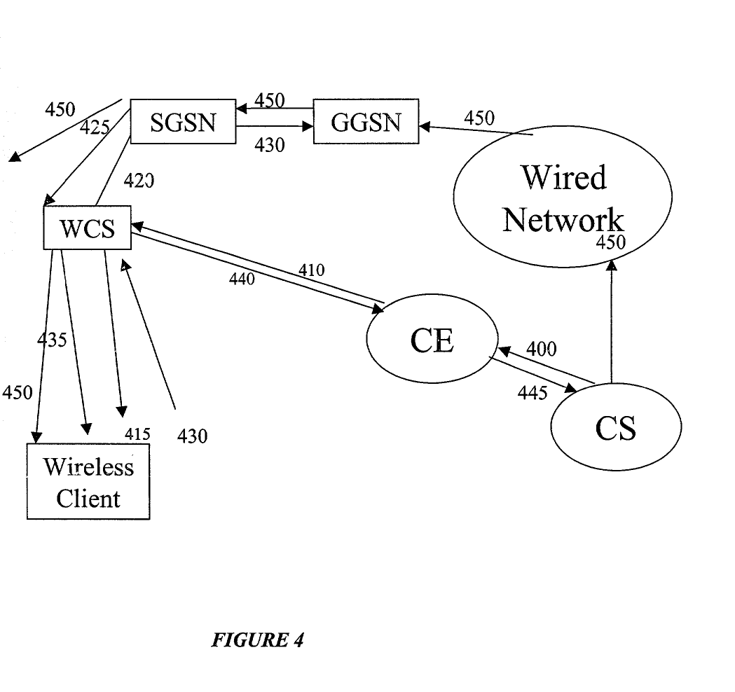

Referring now to FIG. 4, there is illustrated a signal flow diagram describing the establishment of a server initiated client/server connection. The content server 110 initiates the client/server connection by transmitting a request (signal 405) for a data connection with a particular identified wireless client 105 to the content enabler 135. The wireless client 105 can be identified by, for example, an International Mobile Subscriber Identifier (IMSI) or Mobile Services International Subscriber Directory Number (MSISDN). Responsive thereto, the content enabler 135 transmits a signal (signal 410) to the wireless content switch 105 associated with the SGSN 310 serving the particular identified wireless client 105, requesting a server initiated data connection.

Transmission of the signal to the wireless content switch 105 associated with the SGSN 310 serving the identified wireless client 105 can achieved in a number of ways. In one case, the content enabler 135 can maintain a table which correlates the identifiers of wireless clients (such as International Mobile Subscriber Identifiers (IMSI), or MSISDN) with identifiers identifying the serving SGSN 310. The foregoing can be maintained by transmission by the wireless content switch 125 of lists of all wireless clients 105 served by the SGSN 310 associated with the wireless content switch 125. Alternatively, the wireless content switch 125 can transmit a signal to the content enabler 135, responsive to each registration of a wireless client 105 with an SGSN 310, identifying the wireless client 105 and the SGSN 310.

Alternatively, signal 410 can be broadcast to all known wireless content switches 125. Responsive thereto, each wireless content switch 125 receiving the signal determines whether the identified wireless client 105 is served by the SGSN 310 associated with the wireless content switch 125. The wireless content switch 125 associated with the identified wireless client 105 can proceed to establish the data connection, while the other wireless content switches 125 can ignore signal 410.

Upon receipt of signal 410, the wireless content switch 125 implements the NS-VC/BSSGP/LLC/SNDCP stack or subset of the stack with session manager (SM) as defined in the GPRS specification, determines the BSS 315 serving the wireless client 105, and transmits a Request PDP Activation (signal 415) to the wireless client. The Request PDP Activation includes an address associated with the content server 110. Receipt of the PDP Activation message (signal 415) causes the wireless client 105 to request establishment of a data connection with the content server 110. Establishment of the data connection is commenced by the PDP context activation procedure (signals 430), pursuant to GPRS specifications. During the PDP activation procedure, the SGSN 310 and the GGSN 315 establish a tunnel for the transmission of data packets to the wireless client 105. Once the PDP activation procedure (signals 430) is successful, the SGSN 310 transmits an Activate PDP Context Accept message (signal 435) to the wireless client 105 which includes an address associated with the wireless client 105. The foregoing message is transmitted to the client via the wireless content switch 125. The wireless content switch extracts the address information from signal 435 and transmits the address information to the requesting content enabler 135 (signal 440). The content enabler 135 then forwards the address information to the requesting content server 110 (signal 445). The content server 110 then uses the address information to transmit data to the wireless client 105.

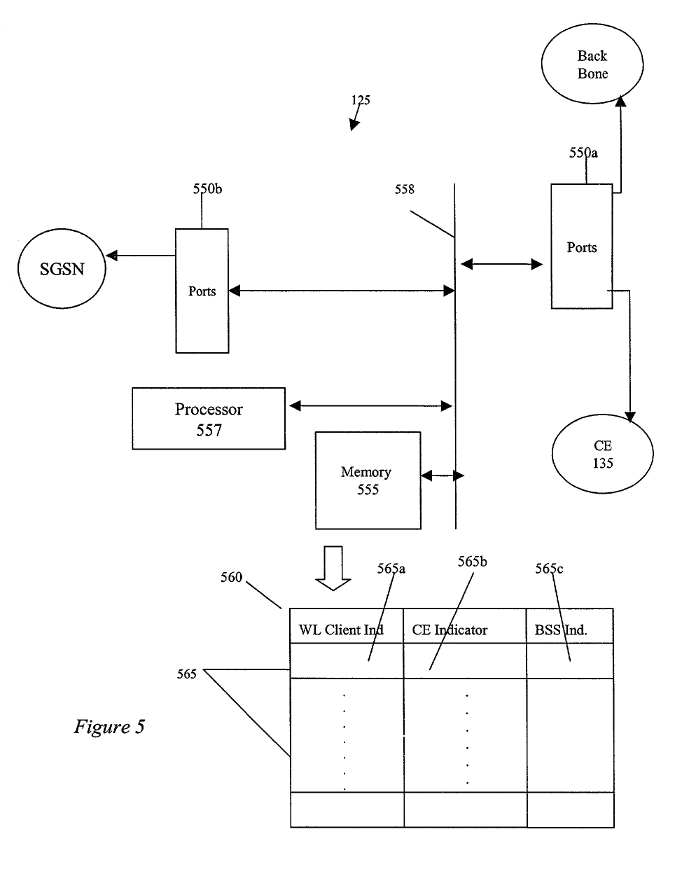

Referring now to FIG. 5, there is illustrated a block diagram of an exemplary wireless content switch 125. The wireless content switch 125 includes any number of upstream ports 550a and downstream ports 550b. The upstream ports 550a facilitate connection of the wireless content switch 125 towards the content server 110 side of the network via a data transport mechanism, such as, for example, a T1, E1, or an Ethernet connection, to name a few. The downstream ports 550b facilitate connection of the wireless content switch 125 towards the wireless client 105, via a similar data port transport mechanism.

In one embodiment, one of the upstream ports 550a facilitates connection of the wireless content switch 125 to the SGSN 310, while one of the downstream ports 550b facilitates connection of the wireless content switch 125 to the BSSs 315. Additionally, at least one of the upstream ports 550a facilitates connection of the wireless content switch 125 with at least one content enabler 130.

The foregoing permit the wireless content switch 125 to receive all signals transmitted to and from the associated SGSN 310 via ports 550, such as the PDP Context Activation Procedure and the Activate PDP Accept. Additionally, the wireless content switch 125 can transmit the Request PDP Activation to the wireless client 105 using a downstream port 550b. The wireless content switch 125 also receives the request for a server initiated data connection from the content enabler 135 uses an upstream port 550a. The upstream port 550a is also used to transmit the IP address associated with the wireless client 105 to the content enabler 135.

The wireless content switch 125 also includes memory 555 for storage of a wireless client table 560. The wireless client table 560 stores any number of records 565, wherein each record is associated with a particular wireless client 105 served by the SGSN 310 associated with the wireless content switch 125. Those skilled in the art will recognize that when a wireless client 105 commences service with particular SGSN 310, the wireless client 105 sends signals identifying itself. The foregoing signals also include an identifier identifying the BSS 315 serving the wireless client 105. The signals are also received by the wireless content switch 125. Therefore, responsive to registration of a wireless client 105 with the SGSN 310, the wireless content switch 125 can create a record for the wireless client 105. The records 565 include a wireless client indicator 565a identifying the wireless client 105 associated with the record 565, a content enabler identifier 565b, and a BSS identifier 565c for storing the received identifier identifying the BSS 315.

Wherein a content server 110 associated with a content enabler 135 requests a data connection with the wireless client 105, the wireless content switch 125 uses the wireless client table 560 to store an identifier identifying the content enabler 135 at content enabler identifier 565b of the record associated with the identified wireless client 105.

As noted above, the wireless content switch 125 transmits a Request PDP Activation message to the wireless client 105 (signal 415). The wireless content switch 125 determines the BSS 315 serving the wireless client 105 by retrieving the BSS identifier 565c of the record 560 associated with the wireless client 105. Additionally, during the Context Activation Procedure, the IP address associated with an identified wireless client 105 is received at wireless content switch 125 either at upstream port 550a or downstream port 550b. The identifier identifying the wireless client 105 in the signal is used to match the wireless client indicator 565a of the record 565 associated with the identified wireless client 105. The content enabler indicator 565b of the record 565 identifies the requesting content enabler 135 and is used to transmit the IP address for the wireless client 105 to the content enabler 135 associated with the requesting content server 110.

Additionally, memory 555 can also store a plurality of executable instructions which are executed by a processor 557. The memory 555, the processor 557, the upstream ports 550a, and the downstream ports 550b are interconnected by a bus 558.

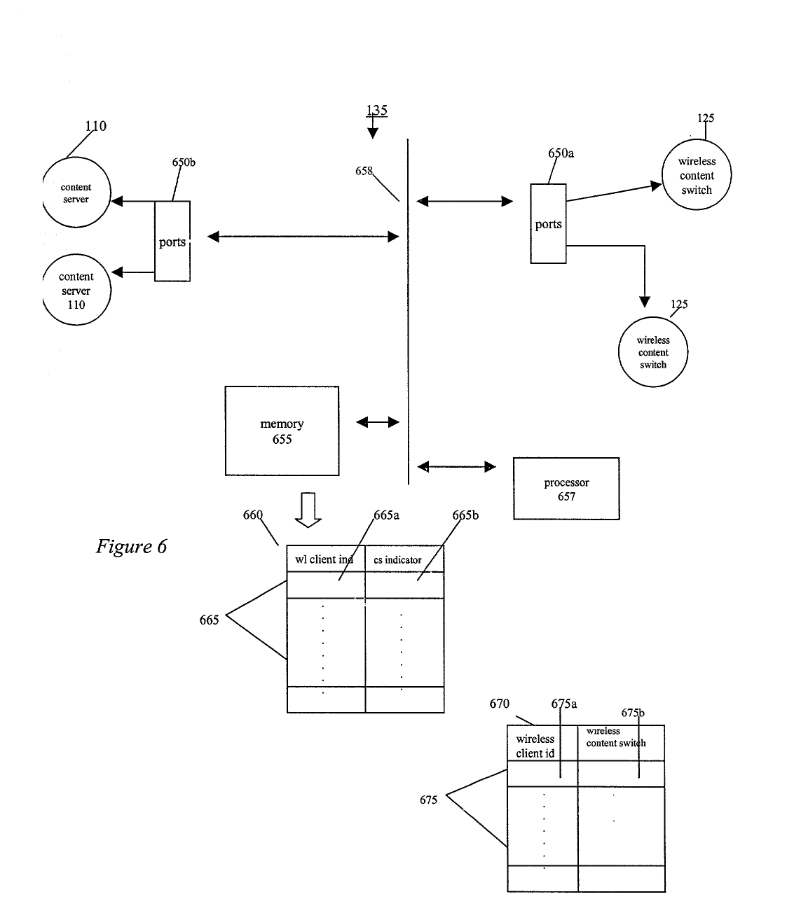

Referring now to FIG. 6, there is illustrated a block diagram describing an exemplary content enabler 135. The content enabler 135 includes any number of Wireless Content Switch Ports 650a and any number of content enabler ports 650b. The wireless content switch ports 650a facilitated connection with any number of wireless content switches 125. The content server ports 650b facilitate connection with any number of content servers 110 served by the content enabler 135.

The content enabler 135 also includes memory 655 which can store executable instructions for execution by a processor 657. The wireless content switch ports 650a, content server ports 650b, the memory 555, and the processor 657 are all interconnected by a bus 658.

The memory 655 also stores a wireless client/server table 660. The wireless client table includes a plurality of records 665. Each record 665 is associated with a particular content server 110 that is served by the content enabler 135, and contains a wireless client identifier 665a and a content server identifier 665b.

Wherein a content server 110 served by the content enabler 135 requests a data connection with a particular identified wireless client 105, e.g., signal 405, the content enabler 135 creates a record 665 and stores an identifier identifying the content server 110 in as the content server identifier 665a and stores the identifier of the wireless client 105 as the wireless client identifier 665a.

As noted above, the content enabler 135 receives an IP addresses associated with identified wireless clients 105, e.g., signal 445, at wireless content switch port 650a. Upon receipt of the signal, the content enabler 135 determines the content server 110 requesting a data connection with the identified wireless client 105. The identifier identifying the wireless client 105 in the signal is used to match the wireless client indicator 665a of a record 665. The content server identifier 665b of the record 665 is used to determine the requesting content server 110. Accordingly, the IP address is sent to the content server 110 identified by the content server identifier 665b, e.g., signal 450, via content server port 650b.

As also noted above, the content enabler 135 can transmit the signal to the wireless content switch 125 associated with the SGSN 310 serving a particular wireless client, either by broadcasting or by determining the SGSN 310 serving the wireless client and transmitting to that SGSN 310 only. Wherein the content enabler 135 determines the SGSN 310 serving the wireless client, memory 655 also stores a client location table 670. The client location table 670 includes any number records 675, each of which are associated with a particular wireless client 105. Each record contains an wireless client identifier 675a and a wireless content switch identifier 675b. The wireless client indicators 565a from each wireless content switch 125 are transmitted to each content enabler 135 periodically. Responsive thereto, the content enabler 135 stores the client indicators 565a in the wireless client identifier 665a of the records 665, and an identifier identifying the sending wireless content switch 125 at the wireless content switch identifier 675b.

When the content enabler 135 at the content server port 650a receives a request from a particular content server 110 for a data connection with a particular wireless client 105, e.g., signal 405, the content enabler 135 retrieves the record 675 associated with the wireless client 105. The content enabler 135 then transmits the request for a data connection, e.g., signal 410, via wireless content switch port 550a to the wireless content switch 125 identified by the wireless content switch identifier 675b identified in the record.

Although the foregoing detailed description is described with degree of particularity, it is noted that the embodiments described therein are capable of numerous modifications, and substitutions. One embodiment can be implemented as sets of executable instructions stored in memory 555, 655. Those skilled in the art will recognize that stores of the executable instructions in the memory 555, 655 results in electrical, magnetic, and/or chemical changes in the memory 555, 665. Accordingly, the invention is limited only by the following claims, and equivalents thereof.

What is claimed is:

1. A method for establishing a data connection in a wireless data services network, said method comprising:
receiving a signal requesting a data connection with a particular wireless client by a content server;
transmitting a signal to the wireless client causing the wireless client to request a data connection with the content server;
receiving a signal from a node, said signal embedded with an address associated with the wireless client; and
transmitting the address towards the content server.

2. The method of claim 1, wherein receiving the signal requesting a data connection further comprises:
receiving the signal requesting the data connection from a content enabler, wherein the content enabler receives the signal requesting the data connection from the content server.

3. The method of claim 1, wherein transmitting a signal to the wireless client comprises transmitting a Request PDP Activation signal to the wireless client.

4. The method of claim 1, wherein transmitting a signal to the wireless client further comprises determining a base station serving the wireless client.

5. The method of claim 1, wherein receiving a signal from a node further comprises receiving an Activate PDP Accept signal from a Serving General Packet Radio Services Support Node (SGSN) embedded with an Internet Protocol (IP) Address.

6. The method of claim 1, wherein transmitting the address towards the content server, further comprises transmitting the address to a content enabler, wherein the content enabler transmits the address to the content server.

7. A wireless for establishing data connections in a wireless data services network, said method comprising:
at least one upstream port for receiving signals requesting data connections with particular wireless clients by content servers and transmitting addresses associated with the wireless clients towards the content servers; and
at least one downstream port for transmitting signals to wireless clients, said signal causing the wireless clients to request data connections with the content servers;
wherein the upstream port receives signals embedded with the addresses associated with the wireless clients from a node.

8. The wireless content switch of claim 7, further comprising:
a memory for storing a wireless client table comprising a plurality of records, wherein each of said records is associated with a particular wireless client and further comprise:
a wireless client indicator for identifying the particular wireless client associated with the record; and
a content enabler indicator for identifying a particular content enabler associated with a particular content server requesting the data connection with the particular wireless client.

9. The wireless content switch of claim 8, wherein the upstream port transmits the address associated with a particular wireless client to the content enabler identified by the content enabler indicator in the record associated with the particular wireless client.

10. The wireless content switch of claim 8, wherein the wireless client identifier comprises an International Mobile Subscriber Identifier.

11. The wireless content switch of claim 8, wherein the wireless client identifier comprises a mobile station international subscriber directory number.

12. The wireless content switch of claim 8, wherein each of the records further comprise:
a base station system identifier identifying the base station system serving the wireless client associated with the record.

13. The wireless content switch of claim 12, wherein the at least one downstream port transmits signals to the wireless clients via the base station system identified by the base station identifier in the record associated with the wireless client.
